(19) United States
(12) Patent Application Publication
(10) Pub. No.: US 2022/0121935 A1
(43) Pub. Date: Apr. 21, 2022

(54) ANOMOLOUS SYSTEM STATE ANALYTICS

(71) Applicant: Hewlett-Packard Development Company, L.P., Spring, TX (US)

(72) Inventor: Robert Gregory Campbell, Palo Alto, CA (US)

(73) Assignee: Hewlett-Packard Development Company, L.P., Spring, TX (US)

(21) Appl. No.: 17/427,247

(22) PCT Filed: Feb. 7, 2019
(86) PCT No.: PCT/US2019/017086

§ 371 Date: Jul. 30, 2021

(51) Int. Cl. G06N 3/08

(52) U.S. Cl. CPC G06N 3/08

(57) ABSTRACT

In an example implementation according to aspects of the present disclosure, a system may include a controller and non-volatile memory. The controller may query and receive a configuration from a system. The controller may query a se of system state analytics from the system. The controller may receive an indication of an anomalous state of the system. The controller may tag and create a record based on the tag and the set of analytics. The controller may input the record into an artificial neural network and receive a source of the anomalous state. The controller may then correct the source of the anomalous state.

### BACKGROUND

Computer systems execute various software programs on various pieces of hardware. A user's perception of the performance of a computer system is dependent on the interaction between the software programs and the hardware.

### BRIEF DESCRIPTION OF THE DRAWINGS

FIG. 1 illustrates a system for receiving anomalous system state analytics, according to an example;

FIG. 2 is a block diagram of a device for receiving anomalous system state analytics, according to an example;

FIG. 3 is a flow diagram illustrating a method for receiving anomalous system state analytics, according to another example of the present disclosure; and

FIG. 4 is a computing device for instructions for the for receiving anomalous system state analytics, according to an example.

### DETAILED DESCRIPTION

Computer systems utilize many different combinations of software, firmware and hardware to execute the applications on which users rely. During normal operation, in which a user is able to productively use the computer system, the combination works efficiently and effectively. However, often the operation of the combination of the software, firmware, and hardware are insular from each other. One component can enter an anomalous state based on the state of another component of the combination. Often this anomalous state may be evident as a degraded user experience. As the system itself does not have transparency into the perceived user experience, the system may not autocorrect the anomalous state. Described herein is a system, a device, and a computing readable medium for receiving anomalous system state analytics.

In one example, a system utilizes a controller and memory to receive a system configuration. The system receives sets of system state analytics corresponding to the subsystems of the computer system. A tag may be received from a user indicating a degraded user experience based on an anomalous system state. The controller creates a record tagging the system state analytics as anomalous. The system may transmit the record to an artificial neural network (ANN). The ANN may utilize the record for training purposes and as part of the feedback loop. The ANN may provide a source of the anomalous state. The system receives the source of the anomalous state and correct the source.

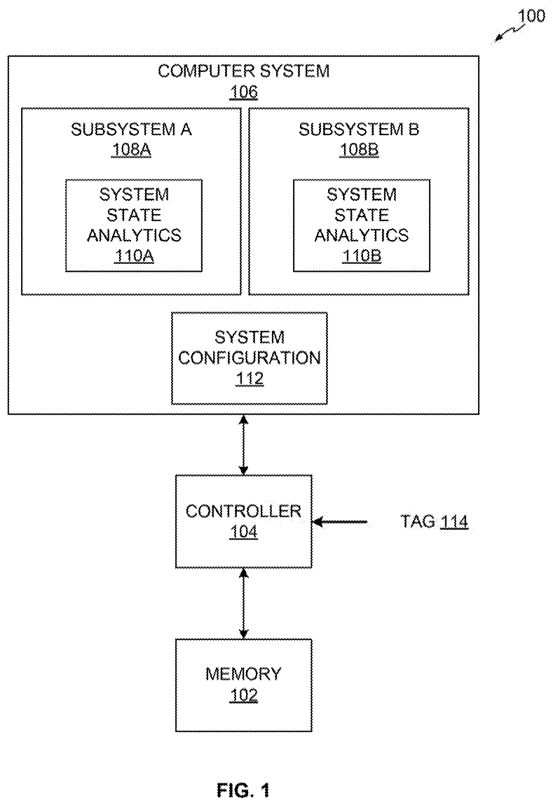

FIG. 1 illustrates a system 100 for receiving anomalous system state analytics, according to an example. The system 100 may include memory 102, a controller 104, and a computer system 106.

The controller 104 may interface with the computer system 106. The controller 104 may be configured to send queries and receive responses from the computer system 106. The controller may be a dedicated piece of hardware, including but not limited to application-specific integrated circuits (ASIC), field-programmable gate arrays (FPGA), or general-purpose computer processors. In another example, the controller 104 may be a software-based controller designed to execute on the computer system 106 and subsequently utilize resources of the computer system. The controller 104 may be designed to utilize standardized system level application programming interface (API) calls to interface with the computer system 106. Additionally, the software-based controller may receive indication of anomalous system state through a graphical user interface indicator or through voice commands via a natural language processing system integrated into the computer system 106.

The controller 104 interface the computer system 106 to periodically request or retrieve system state analytics 110A, 1106. In one implementation, the controller 104 may provide a query or request for system state analytics 110A, 1106 and receive a response with the respective system state analytics. In another implementation, the controller 104 may retrieve the system state analytics 110A, 1106 directly. The controller 104 may store the received system state analytics 110A, 1106 in memory 102. The memory 102 may be a non-volatile memory with sufficient write speed to support the receipt and subsequent writing of the system state analytics 110A, 112A by the controller 104. In another implementation, the memory 102 may include a multi-level memory system of volatile memory for initial storage followed by writing the system state analytics 110A, 112A to a non-volatile memory for longer term storage.

The computer system 106 may be the target of the analytics. The computer system 106 may include a number of subsystems. The subsystems may include both hardware and software systems. The hardware subsystems may include but are not limited to central processing units, memory modules. Motherboard interfaces, graphics adapters, and network interfaces. Software subsystems may include but not be limited to operating systems, device drivers, and applications. The subsystems interact within the context of the computer system 106 to provide the user a useful and productive experience. The subsystems provide system support to execute user applications on the computer system 106.

Subsystem A 108A may be one of many subsystems internal to the computer system 106. Subsystem A 108A may include additional subsystems in a logical grouping. For example, as mentioned previously, subsystem A 108A may include hardware subsystems as a logical group. In another implementation, subsystem A 108A may correspond to a single subsystem, such as central processing unit (CPU) utilization.

Accordingly, subsystem A 108A has associated system state analytics 110A. The system state analytics may provide a snapshot into the state of the subsystem A 108A. For example, system state analytics 110A may correspond to CPU utilization. The system state analytics 110A may include metrics related to CPU utilization. In this example, the system state analytics 110A may include but not be limited to metrics for per core utilization, CPU idle percentage, current per core clock speed, CPU temperature, and CPU wait time. In other examples, system state analytics 110A may correspond to other hardware systems and associated metrics such as graphics processor utilization, memory utilization, and network connection information. The system 100 may access hardware related system state analytics 110A via operating system provided APIs.

In another example, subsystem B 108B may correspond to a software-based subsystem of the computer system 106. In this example, the system state analytics 110B may correspond to software related metrics. The system state analytics 110B in this example may include memory usage, library dependencies, system calls, process identification information, debugging messages, and state machine snapshots.

A system configuration 112 may also be utilized by the system 100. The system configuration corresponds to the logical configuration of the computer system 106, including the subsystems 108A, 108B. System configuration 112 may provide a high-level system wide view identifying all subsystems and system state analytics present in the system. Additionally, the system configuration 112 may provide granular information corresponding to the computer system 106. For example, within the system configuration 112 corresponding to subsystem B 108B, the system configuration 112 may include entries corresponding to device driver packages, identifying specific files and file locations corresponding to the system configuration. In this example, the system configuration 112 may also include the installed versioning information, file permissions, file owners, and installation dates. The system configuration 112 provides an analyst or an ANN details related to the anomalous system state.

The controller 104 may receive a tag 114. In one example, a tag 114 may be signal received by the controller 104. The signal may include an indication of anomalous system state. The tag 114 indicates the controller to identify any received system state analytics 110A, 110B received during a period before and after the tag 114 as being indicative of anomalous system state. Upon the receipt of the tag 114, the controller 104 may write the system state analytics 110A, 110B to the memory 102 with an indication of the receipt of the tag 114.

In some implementations, the controller 104 may update system state analytics 110A, 110B received within a delta time prior to the tag 114 with the indication to indicate the computer system 106 may be in the anomalous state prior to the receipt of the tag 114. Additionally, a timer may be utilized starting upon the receipt of the tag 114, to indicate when the anomalous state ends. For example, five minutes after the receipt of the tag 114, the anomalous state ends, unless another tag is received 114 at which point the timer is reset. In this example, the controller 104 may write the system state analytics 110A, 110B and the indication to memory 102.

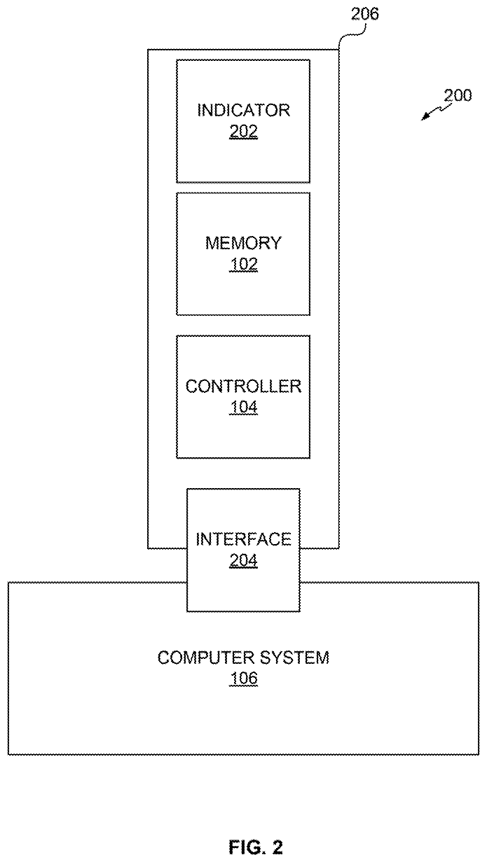

FIG. 2 is a block diagram 200 of a device 206 for receiving anomalous system state analytics, according to an example. The device 206 for receiving anomalous system state analytics may include memory 102, controller 104 and a computer system 106 similar to those reference in FIG. 1. The device 206 may be a separate hardware component from the computer system 106. The device 206 may include a printed circuit board to host the memory 102, the controller 104, an indicator 202, and an interface 204.

The indicator 202 may be electrically coupled to the controller 104. The indicator 202 may be utilized for receiving a tag 114 from the user. The indicator 202 may be an electromechanical switch such as a push button switch. In another implementation, the indicator 202 may be a knob with states representing normal operation and an anomalous system state. In another implementation, the indicator 202 may be a microphone capable of receiving voice indications corresponding to a tag of an anomalous system state.

An interface 204 may allow the device 206 to interact with the computer system 106. The interface 204 may be a hardware interface physically in electrical contact with the computer system 106. The interface 204 may be implemented as universal serial bus or ethernet. In another implementation, the interface 204 may be a wireless communication protocol including but not limited to WiFi, Bluetooth, or Zigbee. To support wireless communication, device 206 may also utilize a radio frequency transceiver (not shown).

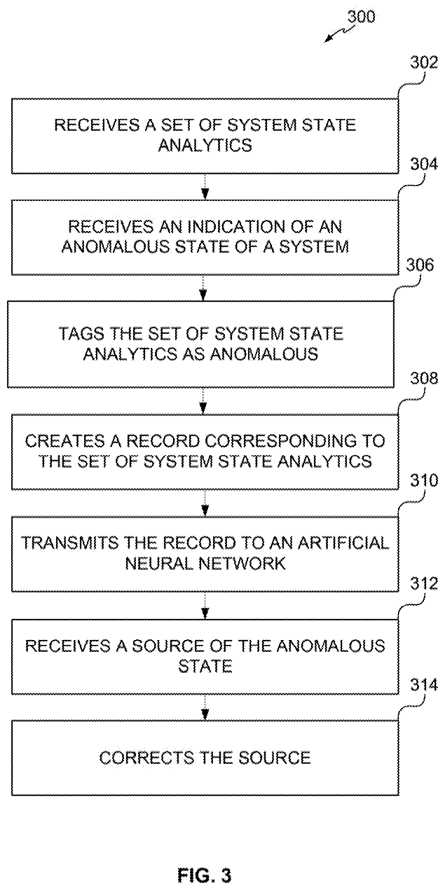

FIG. 3 is a flow diagram 300 illustrating a method for receiving anomalous system state analytics, according to another example of the present disclosure.

At step 302, the controller 104 receives a set of system state analytics. The controller 104 may receive the set of system state analytics from a computer system via direct electrical connection via an interface, as discussed above. In another example, the controller 104 may receive the set of system state analytics over a radio frequency wireless transmission. The receipt of the set of system state analytics may be periodic based on a polling interval. The polling interval may be different during a period of normal system state versus anomalous system state. In one implementation, by default, a received set of system state analytics may be tagged as normal so long as an indication of an anomalous state of the system has not been received.

At step 304, the controller 104 receives an indication of an anomalous state of the computer system. The user may provide the controller 104 with an indication of anomalous system state via the indicators discussed previously. The user may press an electromechanical button, turn an electromechanical knob, select a graphical user interface indication, or provide a voice command to a natural language processor integrated into the computer system 106.

At step 306, the controller 104 tags the set of system state analytics as anomalous. Upon the receipt of the indication, the controller 104 labels the set of system state analytics as anomalous. In one implementation, the controller 104 may set a flag in memory corresponding to receive set of system state analytics corresponding to when the indication was received. The flag may be a toggle bit.

At step 308, the controller creates a record corresponding to the set of system state analytics. Upon tagging the set of system state analytics, the controller 104 creates a record corresponding to the anomalous system state. The record may be formatted in a data structure ready for ingest by an ANN. In another example, the record may be formatted in a standardized data structure accessible by a number of applications. For example, the record may be written into an extensible markup language (XML) tree or a JavaScript object notation (JSON) object. Fields for an XML or JSON implementation may be determined by the system configuration 112. Additionally, the record may be formatted for API based ANN interfaces such as WinML. In a voice command enabled implementation, the record may also include additional user provided information. In another implementation, the user may also provide textual context to the record via keyboard input. The additional user provided information may provide insight as to the anomalous system state. For example, the user may provide additional information indicating “video froze” while watching an online video.

At step 310, the controller 104 transmits the record to an artificial neural network. The controller 104 may transmit the record to the ANN utilizing wired or wireless protocol. In a networking enabled implementation, the controller 104 may transmit the record to the ANN over a local area network (LAN), a wide area network (WAN), or the Internet. In an implementation utilizing a hardware-based controller physically separable from the computer system 106, the controller 104 may transmit the record upon physically interfacing a host system containing the ANN. The ANN may utilize any records as training data for the ANN or as feedback loop data for verification of the ANN. The ANN processes the record within the ANN model to identify a potential source of the anomalous system state.

At step 312, the controller 104 receives a source of the anomalous state. The controller receives the source of the anomalous system state from the ANN. In some implementations, the source may be received over the same transport as the transmittal. For example, if the transmittal was over the internet, the receipt of the source may also be facilitated over the internet. The source may be identified with a code which the controller 104 may be able to interpret as well as additional data to facilitate the corrective action. For example, execution permissions on a file may be indicated by a code. Additionally, the source may include the path to the offending file, an indication as to the corrective result (e.g. set file to executable), as well as the path to a utility application to correct the source.

At step 314, the controller 104 corrects the source. The controller 104 utilizes the system configuration 112 in conjunction with the source identified to correct the anomalous state. For example, the controller 104 utilizes the data from the ANN to identify the type of the problem, a fix for the problem, and additional details to facilitate that result, as described above. In some implementations, the controller 104 may even halt the execution of a program executing on the system.

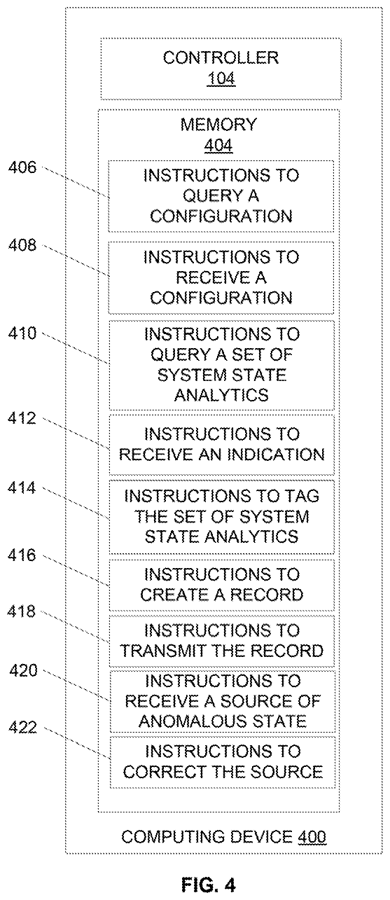

FIG. 4 is a computing device for instructions for the for receiving anomalous system state analytics, according to an example. The computing device 400 depicts a controller 104 and a memory 102 and, as an example of the computing device 400 performing its operations, the memory device 404 may include instructions 406-422 that are executable by the controller 104. The controller 104 may be synonymous with the processor found in common computing environments including but not limited to central processing units (CPUs). The memory device 404 can be said to store program instructions that, when executed by controller 104, implement the components of the computing device 400. The executable program instructions stored in the memory device 404 include, as an example, instructions to query a configuration 406, instructions to receive a configuration 408, instructions to query a set of system state analytics 410, instructions to receive an indication 412, instructions to tag the set of system state analytics 414, instructions to create a record 416, instructions to transmit the record 418, instructions to receive a source of anomalous state 420, and instructions to correct the source of the anomalous state 422.

Memory device 404 represents generally any number of memory components capable of storing instructions that can be executed by controller 104. Memory device 404 is non-transitory in the sense that it does not encompass a transitory signal but instead is made up of at least one memory component configured to store the relevant instructions. As a result, the memory device 404 may be a non-transitory computer readable medium. Memory device 404 may be implemented in a single device or distributed across devices. Likewise, controller 104 represents any number of processors capable of executing instructions stored by memory device 404. Controller 104 may be integrated in a single device or distributed across devices. Further, memory device 404 may be fully or partially integrated in the same device as controller 104, or it may be separate but accessible to that device and controller 104.

In one example, the instructions 406-422 can be part of an installation package that, when installed, can be executed by controller 104 to implement the components of the computing device 400. In this case, memory device 404 may be a portable medium such as a CD, DVD, or flash drive, or a memory maintained by a server from which the installation package can be downloaded and installed. In another example, the program instructions may be part of an application or applications already installed. Here, memory device 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a non-volatile memory; and
a controller to:
query a configuration of a system;
receive, responsive to the query, a system configuration;
query a set system state analytics from a set of subsystems, wherein the set of system state analytics are tagged as normal;
receive, from a user, an indication of an anomalous state of the system;
tag, responsive to the indication, the set of system state analytics as anomalous;
create a record corresponding to the set of system state analytics, wherein the record comprises additional user supplied information;
input the record into an artificial neural network, wherein the record trains the artificial neural network;
identify a source of the anomalous state of the system based on a classification from the artificial neural network, wherein the source is based on at least in part an entry in the system configuration; and
correct the source of the anomalous state.

2. The system of claim 1, wherein the controller receives the indication through a voice activated command system.

3. The system of claim 1, wherein the correcting the source of the anomalous state comprises halting the execution of a program executing on the system.

4. The system of claim 1, wherein the additional user supplied information corresponds to characteristics of the anomalous state of the system.

5. The system of claim 1, wherein the set of system state analytics comprises network connection information, central processing unit utilization information, graphics processing unit utilization information, and applications executing on the system.

6. A device comprising:
a non-volatile memory; and
an interface between a controller and a system, wherein the controller is configured to:
query a configuration of the system via the interface;
receive, responsive to the query, the system configuration via the interface;
query a set system state analytics via the interface from a set of subsystems, wherein the set of system state analytics are tagged as normal;
store the set of system state analytics in the non-volatile memory;
receive, from a user, an indication of an anomalous state of the system;
tag, responsive to the indication, the stored set of system state analytics as abnormal;
create a record corresponding to the set of system state analytics, wherein the record comprises additional user supplied information;
input the record into an artificial neural network via a second interface corresponding to an analyzing system; and
receive an identified source of the anomalous state of the system based on a classification from the artificial neural network, wherein the identified source is based on at least in part an entry in the system configuration.

7. The device of claim 6, wherein the controller receives the indication through an electromechanical switch.

8. The device of claim 6, wherein the interface comprises universal serial bus.

9. The device of claim 6, wherein the record corresponds to a training dataset for the artificial neural network.

10. The device of claim 6, wherein the configuration of a system comprises device driver information, network connection information, central processing unit utilization information, graphics processing unit utilization information, and applications executing on the system.

11. A computer readable medium comprising a memory having instructions stored thereon and a controller configured to perform, when executing the instructions to:
query a configuration of a system;
receive, responsive to the query, a system configuration;
query a set system state analytics from a set of subsystems, wherein the set of system state analytics are tagged as normal;
receive, from a user, an indication of an anomalous state of a system;
tag, responsive to the indication, the set of system state analytics as abnormal;
create a record corresponding to the set of system state analytics, wherein the record comprises additional user supplied information;
transmit the record to an artificial neural network;
receive a source of the anomalous state of the system based on a classification from the artificial neural network, wherein the source is based on at least in part an entry in the system configuration; and
correct the source of the anomalous state.

12. The computer readable medium of claim 11, wherein receives the indication through a voice activated command system.

13. The computer readable medium of claim 11, wherein the correcting the source of the anomalous state comprises halting the execution of a program executing on the system.

14. The computer readable medium of claim 11, wherein the record corresponds to a training dataset for the artificial neural network.

15. The computer readable medium of claim 11, wherein the configuration of a system comprises device driver information, network connection information, central processing unit utilization information, graphics processing unit utilization information, and applications executing on the system.
